(19) United States
(12) Patent Application Publication
(10) Pub. No.: US 2005/0206173 A1
(43) Pub. Date: Sep. 22, 2005

(54) Tailgate latch structure of vehicle

(76) Inventor: Nam Hyeok Lim, Gunpo (KR)

Correspondence Address: MORGAN, LEWIS & BOCKIUS LLP (SF), 2 PALO ALTO SQUARE, PALO ALTO, CA, 94306, US

(21) Appl. No.: 11/010,011

(22) Filed: Dec. 10, 2004

(30) Foreign Application Priority Data
Mar. 22, 2004 (KR) 2004-0019287

(51) Int. Cl. E05C 3/06

(52) U.S. Cl. 292/216

(57) ABSTRACT

The tailgate latch structure of a vehicle is adapted to prevent excessive pivoting of a pawl lever via a stopper formed at the bottom of a latch body, thereby precluding a locking malfunction of a tailgate latch. A smooth switch operation is performed via a ball-type electric switch installed at the latch body. The convenience of the opening and closing manipulation of the tailgate is improved and the durability of the tailgate latch system is increased.

### CROSS-REFERENCE TO RELATED APPLICATIONS

The present application is based on, and claims priority from, Korean Application Number 10-2004-0019287, filed on Mar. 22, 2004, the disclosure of which is hereby incorporated by reference herein in its entirety.

### FIELD OF THE INVENTION

The present invention relates to a tailgate latch structure of a vehicle.

### BACKGROUND OF THE INVENTION

Generally, a tailgate is equipped at the rear of a vehicle for loading or unloading an object into a vehicle. A lift-up type is typically used in the tailgate. The lift-up type tailgate is installed with hinges at both upper ends of the tailgate. The tailgate is, therefore, opened and closed in a rotating motion via hinges.

The lower end of the tailgate is formed with an outdoor handle to operate the tailgate from the exterior of the vehicle. An opening and closing device constitutes a latch that locks and unlocks the tailgate to the vehicle body according to the manipulation of the outdoor handle.

The tailgate latch conventionally includes an open lever, fork lever, and pawl lever. The open lever is manipulated by the outdoor handle. The fork lever locks the tailgate to a striker. The pawl lever controls the operation of the fork lever according to the operation of the open lever. An electric switch is also installed inside the tailgate latch to illuminate lights when opening the tailgate. The tailgate latch thus described should stably be operated.

### SUMMARY OF THE INVENTION

Embodiments of the present invention are provided to restrain an excessive pivoting of a pawl lever installed at a tailgate latch, thereby obtaining a stable operation of the tailgate. A smoothly operating electric switch is also provided in the present invention.

A tailgate latch structure of a vehicle comprises a latch body. A fork lever is installed at the bottom of the latch body and is pivoted to be locked or unlocked with a striker. A pawl lever is installed at the bottom of the latch body and maintains or releases a locked state of the fork lever by a pivoting motion, wherein the fork lever locks with the striker. A stopper protrudes out from the latch body for preventing an excessive pivoting of the pawl lever when the pawl lever restores to the original position after releasing the locked state of the fork lever.

### BRIEF DESCRIPTION OF THE DRAWINGS

For a better understanding of the nature and objects of the present invention, reference should be made to the following detailed description with the accompanying drawings, in which:

FIG. 1 is a perspective view of a tailgate latch structure according to an embodiment of the present invention;

FIG. 2 illustrates the bottom of the latch body of FIG. 1 according to an embodiment of the present invention;

FIG. 3 is a schematic view of the internal components of FIG. 1 except the upper bracket, latch body, and lower bracket;

FIG. 4 is a sectional view taken along line IV-IV of FIG. 1; and

FIG. 5 illustrates the bottom of the latch body of FIG. 1 according to another embodiment of the present invention.

### DETAILED DESCRIPTION OF THE PREFERRED EMBODIMENTS

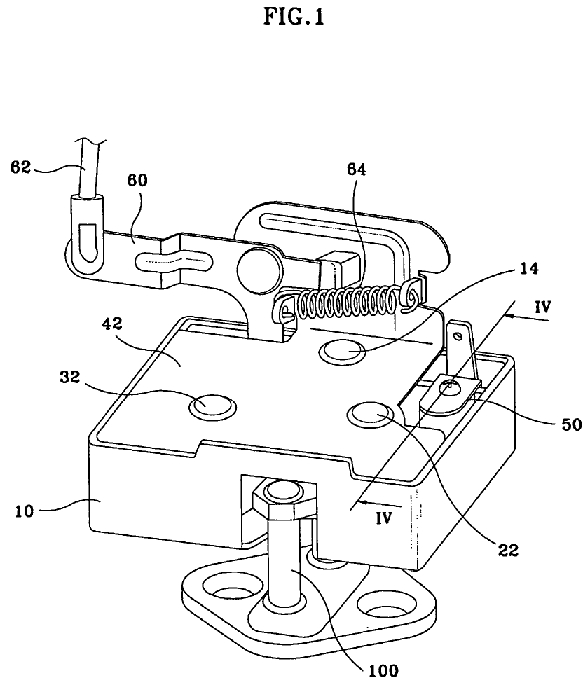

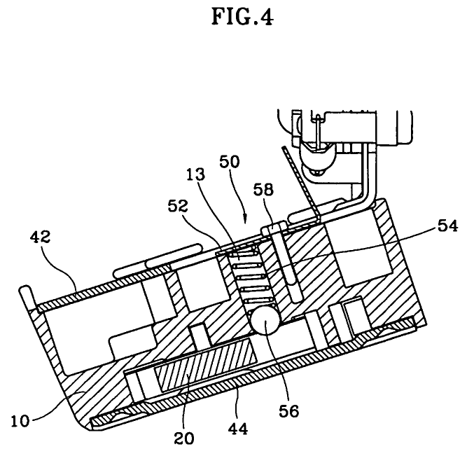

As illustrated in FIGS. 1 to 4, a tailgate latch structure of a vehicle according to an embodiment of the present invention comprises a stopper 12 protruding out from the bottom of a latch body 10. An electric switch 50 is installed inside the latch body 10.

More particularly, the tailgate latch device of a vehicle includes the latch body 10 having a vertically formed operation hole 11. An open lever 60 connects at one end thereof to an outdoor handle (not shown) via a rod 62. The other end of the open lever 60 is inserted into the operation hole 11 in a state of being resiliently supported by a spring 64. The other distal end of the open lever 60 protrudes out from the bottom of the latch body 10. A pawl lever 30 is affixed to and supported by a pivot shaft 32. The pawl lever 30 is installed at the bottom of the latch body 10 and pivotally engages with the protruded distal end of the open lever 60. A fork lever 20 is installed at the bottom of the latch body 10 for being locked or released via the pawl lever 30. The electric switch 50 is installed inside the latch body 10.

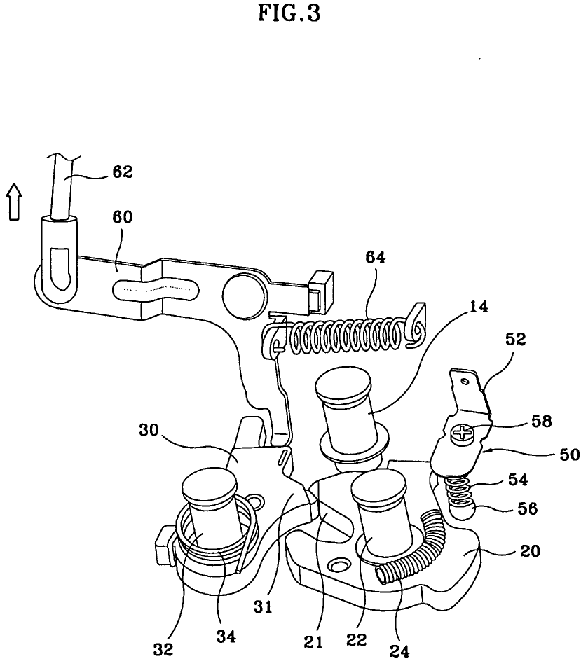

Referring to FIG. 3, the pawl lever 30 is pivotally fixed to the bottom of the latch body 10 via the pivot shaft 32 and receives a spring force in a clockwise direction. The fork lever 20 is fixed at the bottom of the latch body 10 by a pivot shaft 22. The fork lever 20 is resiliently supported by a force provided from a spring in a counterclockwise direction.

As shown in FIG. 3, the spring includes a torsion spring 34 of the pawl lever 30 mounted in a wound state to the pivot shaft 32, and a spring 24 of the fork lever 20 installed at one side of the pivot shaft 22.

The pawl lever 30 partially contacts the fork lever 20 and restrains pivot of the fork lever 20. Thus, the pawl lever 30 can lock or release the fork lever 20.

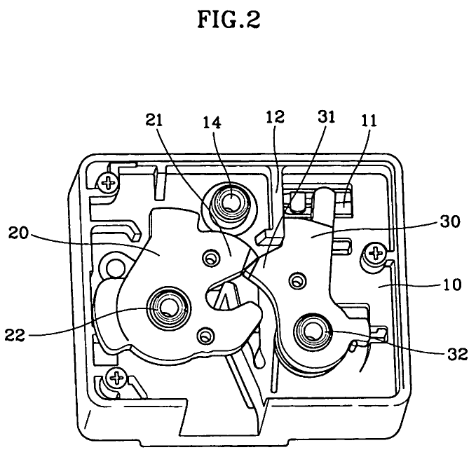

The stopper 12 protrudes out from the bottom of the latch body 10 between the pawl lever 30 and fork lever 20 as illustrated in FIG. 2. One end of the stopper 12 is formed in a rib shape configuration that couples to an edge of the latch body 10. The pawl lever 30 is prevented from being excessively pivoted via the resilient restoring force of the torsion spring 34 equipped around the pivot shaft 32.

The electric switch 50 is constituted by a through hole 13, a spring 54, and a ball 56. The through hole 13 formed in the latch body 10 is narrowed in width at the lower portion thereof. The spring 54 is inserted into the through hole 13 and the upper end of the spring 54 contacts a switch connector 52. The ball 56 is inserted into the through hole 13 and a certain portion of the ball 56 protrudes out to the moving space of the fork lever 20 at the bottom of the spring 54. The ball 56 is preferably used by a conductor for a current flow.

The electric switch is assembled by first inserting the ball 56 into the through hole 13 formed in the latch body 10. Then, the spring 54 is inserted into the through hole 13, and the upper surface of the through hole 13 is covered by the switch connector 52 having a plate-shape configuration for contacting the spring 54. The switch connector 52 is fastened by a bolt 58.

On the other hand, the latch is assembled as follows. The pawl lever 30 and fork lever 20 are assembled at the bottom of the latch body 10. Next, a lower bracket 44 is assembled underneath the pawl lever 30 and fork lever 20. The upper surface of the latch body 10 is assembled with an upper bracket 42 to complete the latch assembly. Reference numeral 14 is a fixing bush that integrally fixes the upper bracket 42, lower bracket 44 and latch body 10.

The operation of the present invention will now be described with reference to FIGS. 1 to 4. As illustrated in FIG. 3, when the rod 62 is pulled by the outdoor handle (not shown) and the open lever 60 pivots, the pawl lever 30 engaged with the open lever 60 pivots in a counterclockwise direction. Thus, a protruder 31 of the pawl lever 30 withdraws from a chin 21 of the fork lever 20 and restrained pivoting state of the fork lever 20 is released.

Accordingly, the fork lever 20 receiving the resilient force in the counterclockwise direction via the spring 24 in relation to the pivot shaft 22 pivots in a counterclockwise direction and releases the locked state of the tailgate from a striker 100.

As the fork lever 20 pivots, a certain portion of the fork lever 20 contacts the ball 56 and raises the ball 56 upwardly. The electric switch 50 receives an electrical signal via the fork lever 20 and thus lights of the passenger compartment illuminate. That is, the current transmitted to the electric switch 50 via the fork lever 20 is applied as a signal current. Because the fork lever 20 and electric switch 50 indirectly contact each other via the ball 56 resiliently supported by the spring 54, a smooth switch operation is carried out.

When the outdoor handle is released from being pulled, the rod 62 is loosened and the open lever 60 is pulled backwardly via the resilient restoring force of the spring 64, thereby releasing the pressure applied to the pawl lever 30. The pawl lever 30 pivots in a clockwise direction by the torsion spring 34 installed around the pivot shaft 32 of the pawl lever 30. The pawl lever 30 is restrained from excessively pivoting at more than a certain angle by the stopper 12 that protrudes out from the bottom of the latch body 10. Therefore, a locking malfunction of the tailgate latch is prevented.

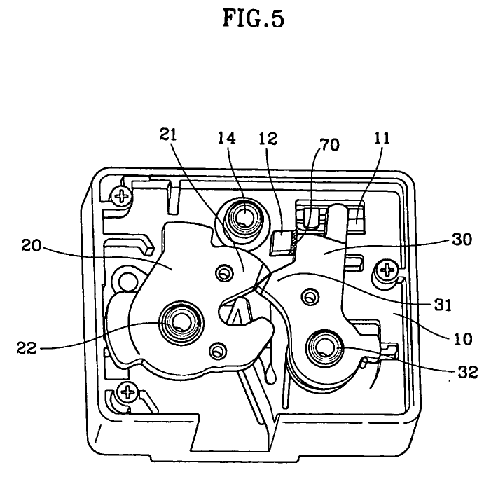

Referring to FIG. 5, the stopper 12 may protrude out from the latch body 10 in a pillar shape according to another embodiment of the present invention. The stopper 12 is further preferably equipped with a shock-absorbing pad 70 at a contact portion with the pawl lever 30. When the pawl lever 30 is restrained in the pivot via the stopper 12, the shock-absorbing pad 70 absorbs the impact as well as reduces noise.

As apparent from the foregoing, there is an advantage in the present invention in that the stopper formed at the bottom of the latch body precludes an excessive pivoting of the pawl lever, contributing to a prevention of a locking malfunction of the tailgate latch. Also, a smooth switch operation is performed via a ball-type electric switch installed at the latch body. As a result, the convenience of the opening and closing manipulation of the tailgate is improved, and the durability of the tailgate latch system of the vehicle is increased via the smooth operation.

1. A tailgate latch structure of a vehicle, the structure comprising:
a latch body;
a fork lever installed at said latch body and pivoted to be locked or unlocked with a striker;
a pawl lever installed at said latch body and maintaining or releasing a locked state of said fork lever by a pivoting motion, where said fork lever locks with said striker;
a fixing bush located between said pawl lever and said fork lever; and
a stopper protruding out from said latch body for preventing excessive pivoting of said pawl lever when said pawl lever restores to the original position after releasing the locked state of said fork lever.

2. The structure as defined in claim 1, wherein said fork lever and said pawl lever are installed at the bottom of said latch body.

3. The structure as defined in claim 1, wherein said stopper protrudes out from said latch body between said pawl lever and said fork lever.

4. The structure as defined in claim 3, wherein one end of said stopper is formed in a rib-shape configuration that couples to an edge of said latch body.

5. The structure as defined in claim 3, wherein said stopper protrudes out from said latch body in a pillar shape.

6. The structure as defined in claim 1, wherein said stopper is further equipped with a shock-absorbing pad at a contacting portion with said pawl lever.

7. The structure as defined in claim 1, wherein said stopper is located between said pawl lever and said fixing bush of said latch body.

8. The structure as defined in claim 1, wherein an electric switch is further provided, comprising:
a through hole formed in said latch body and narrowed in width at the lower portion thereof;
a spring inserted into said through hole, and an upper end of said spring contacts a switch connector; and
a ball inserted into said through hole and a portion of said ball protrudes out to the moving space of said fork lever, and said ball contacts said spring.

9. The structure as defined in claim 1, further comprising an upper bracket and
a lower bracket, wherein said fixing bush is configured to fix the latch body between the upper bracket and the lower bracket.
